(19) United States
(12) Patent Application Publication
(10) Pub. No.: US 2007/0100754 A1
(43) Pub. Date: May 3, 2007

(54) FINANCIAL TRANSACTION NETWORK SECURITY

(76) Inventor: Kerry D. Brown, Portola Valley, CA (US)

Correspondence Address: PATENTS PENDING, 9832 LOIS STILTNER CT, ELK GROVE, CA, 95624, US

(21) Appl. No.: 11/613,427

(22) Filed: Dec. 20, 2006

Related U.S. Application Data
(63) Continuation-in-part of application No. 11/502,772, filed on Aug. 14, 2006.
(63) Continuation-in-part of application No. 11/478,758, filed on Jun. 29, 2006.
Application No. 11/478,758 is a continuation-in-part of application No. 11/404,660, filed on Apr. 14, 2006.
Application No. 11/404,660 is a continuation-in-part of application No. 10/738,376, filed on Dec. 17, 2003, now Pat. No. 7,044,394.

(51) Int. Cl. G06Q 99/00

(52) U.S. Cl. 705/50

(57) ABSTRACT

A business model for the manufacture and control of payment cards used in consumer financial transactions circulates a population of payments cards with user identification and account access codes. Each use of an individual card produces a variation of its user access code according to an encryption program seeded with encryption keys or initialization vectors. A portion of the magnetic stripe is made dynamic with a Q-Chip magnetic MEMS device. The job of personalizing payment cards with the user identification and account access codes is outsourced to a personalization company. The encryption keys and initialization vectors are kept private from the personalization company by using the encryption program to generate tables of computed results. Respective ones of the tables of computed results are sent for loading by the personalization company into new members of the population of payments cards. New payment cards are manufactured and distributed that include and operate with the tables of computed results.

### RELATED APPLICATION

This Application is a continuation-in-part of U.S. patent application Ser. No. 11/502,772, filed Aug. 14, 2006, titled, CONTACT-CONTACTLESS AND MAGNETIC-STRIPE DATA COLLABORATION IN A PAYMENT CARD; and, U.S. patent application Ser. No. 11,478,758, filed Jun. 29, 2006, titled Q-Chip MEMS MAGNETIC DEVICE; which is a continuation-in-part of U.S. patent application Ser. No. 11/404,660, filed Apr. 14, 2006, titled AUTOMATED PAYMENT CARD FRAUD DETECTION AND LOCATION; which was, in turn, a continuation-in-part of now issued U.S. Pat. No. 7,044,394 B2, issued May 16, 2006, and titled, PROGRAMMABLE MAGNETIC DATA STORAGE CARD. These all are incorporated herein by reference.

### BACKGROUND OF THE INVENTION

1. Field of the Invention

The present invention relates to financial transaction systems, and more particularly to end-to-end security of credit card, debit card, payment card, and other commercial transactions.

2. Description of Related Art

Credit cards evolved from simple plastic blanks with embossed numbers that could be imprinted on paper drafts with carbon papers, to those including magnetic stripes that can be read electronically and verified in real time over a supporting network. The magnetic stripes were easy to read and duplicate, so it seemed obvious for the industry to do away with such technology and replace it with a new media that could support encryption. The signature panels where the users were supposed to sign the card, and the merchants were supposed to verify the signature, never really worked as a security measure.

Payment cards further evolved into smart cards with electrical contacts, and then contactless types with wireless interfaces. On-board encryption processors inside the cards were near impossible to spoof or substitute, but they were also expensive and not supported by the many millions of ubiquitous magnetic card readers. Such technologies have put a damper on fraud, and industry losses have declined enough that such cards are charged lower transaction fees.

As has occurred in so many industries and transactions, the physical documents or tokens that are commonly carried by people are no longer accepted at face value. Too many excellent fakes have been circulated, and the world has changed in response. For example, university diplomas themselves used to be proof of a college education, now the admissions records of the university and class transcripts are consulted directly. Deeds to land used to be good title, but the Law long ago required them to be recorded, so the official records of the County Recorder now are the accepted proof of land ownership. Passports used to be stand-alone documents, but now machine-readable passports allow real-time access by passport-control officers into official State Department databases. The same has happened with driver licenses, the actual license really only provides a file access number. Police officers routinely radio-in to get the current status of a license, and the legal status and identity of its holder. But accepting a drivers license as proof-of-drinking-age by a bar is highly susceptible to fraud, because bartenders have no access to the official records or databases. A weakness in the air travel security at airports is that security personnel accept documents provided on-the-spot by travelers at face value, and no independent, machine-readable means to verify them is at hand.

Contact-contactless payment card technologies allow end-to-end financial transaction security because each transaction initiated by the card begins with the card providing unique, verifiable data. The traditional legacy magnetic stripe and embossed credit cards can only provide the same numbers over and over. So once a fraudster obtains those numbers, the account can be tapped over and over until someone puts a stop to it. Even asking for zip codes and home phone numbers is not enough, because these checks too are invariant and valid on every transaction.

Orbiscom's O-Powered technology and Cyota's SecureClick product create real credit card numbers for users when they are ready to pay for their online purchases. These are randomly generated credit card numbers only known by the user and their bank. But devices or cards to generate the correct numbers must be put in the hands of consumers in order for them to use them. Some credit cards themselves include the electronics to generate the “surrogate” numbers, and some token device fobs are used by the likes of CitiBusiness to cryptographically generate passwords synchronized in time to master lists for user authentication.

Such surrogate credit card numbers appear no different to merchants. Their use has the long term effect of reducing fraud costs for everyone. Credit card holders have much better, automatic control over merchants, or others, who would try to use simple copies to generate new transactions like unwanted subscriptions or criminals engaged in bare fraud. The surrogate numbers, if lost, prevent losing anything of value altogether.

Orbiscom's product is offered by a number of major card issuers in the United States, e.g., Discover, MBNA and First Data Corp. Several million card holders have access to O-Powered technology. But such represents a very small slice of the whole population, so banks outsource the job of authenticating their users' card transactions to third parties like Orbiscom and pay a small per transaction fee.

Outsourcing users' cards authentication to third parties runs a real risk for the issuing banks of disintermediation. Cutting out the “middleman” is viewed as a quick path to losing the vast commercial credit card market very quickly to carpetbaggers.

What is needed is a payment card that is compatible with the preexisting on-line use and magnetic-stripe electronic payment infrastructures, and yet the network provides end-to-end financial transaction security where each transaction initiated by the card begins with the card providing unique, verifiable data.

### SUMMARY OF THE INVENTION

Briefly, a financial transaction network security embodiment of the present invention comprises a population of payment cards in the field with magnetic stripes that can be read by legacy card readers ubiquitous throughout the world. Each such payment card includes a Q-Chip™ MEMS magnetic device embedded in part of a magnetic stripe to provide a unique dynamic magnetic data for each transaction. Such unique magnetic data is predictable and is authenticated through the network by a financial transaction server operated by the card issuer, or a designated intermediary. The Q-Chip MEMS magnetic device generates new sub-sets of magnetic data that are written in combination with other permanently recorded magnetic data in the surrounding surface of the magnetic stripe. The dynamic portion automatically provides security to each transaction. A swipe sensor senses swipes with a legacy magnetic stripe card reader, and a transaction event count is useful, for example, to accumulate loyalty program points, to predict when a battery on-board will be exhausted, etc.

An advantage of the present invention is that a payment card security system is provided that is compatible with the existing magnetic-stripe type legacy payment card systems and infrastructure.

A further advantage of the present invention is that a financial network security system is provided that passes only one-time useful data through between the payment card and the card issuer's server. So taps, logs, or copies of these transactions cannot be used for fraud, and intermediate security measures can be relaxed.

Another advantage of the present invention is a secure financial network is provided that can eliminate disintermediation of issuing banks by keeping the job of card user authentication internal.

An additional advantage of the present invention is a card is provided that can communicate its power and functional status to the issuer and transaction network.

An additional advantage of the present invention is the encryption keys held by issuing banks to secure their card populations need not be disclosed to third party card personalization companies.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a secure financial transaction network embodiment of the present invention;

FIG. 2 is a functional block diagram of a payment card system embodiment of the present invention in which wireless smartcard and legacy magnetic card readers are both supported, and information from the smartcard side can be written to the magnetic data tracks on the cards;

FIG. 3 is an exploded assembly diagram showing how a payment card is assembled from laminates, circuit inlays, batteries, and other components that have their surfaces plasma treated for bonding together well enough to pass industry tests for flexing, bending, and peeling;

FIG. 4 is a functional block diagram of a payment system embodiment of the present invention in which shopping coupons can be passed from a contact-contactless payments processing infrastructure to a magnetic stripe infrastructure and vice versa, and from the magnetic stripe infrastructure to the magnetic stripe infrastructure, all linked through the payment card;

FIG. 5 is a functional block diagram of a micropayments system embodiment of the present invention in which coupons are passed from the contact-contactless infrastructure to the magnetic stripe infrastructure through a payment card; and

FIG. 6 is a functional block diagram of a loyalty program system embodiment of the present invention in which transaction counts are passed from the magnetic-stripe infrastructure to the contact-contactless infrastructure through the payment card.

### DETAILED DESCRIPTION OF THE INVENTION

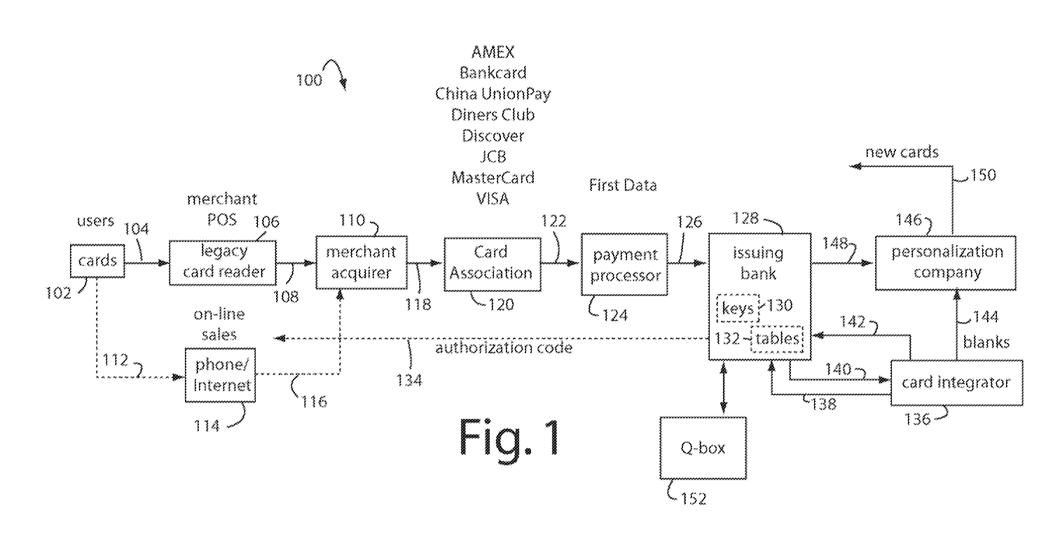

FIG. 1 illustrates a secure financial transaction network embodiment of the present invention, and is referred to herein by the general reference numeral 100. A population of user payment cards is represented here by cards 102. These cards each include dynamic magnetic stripes and/or displays that can change the personal account number (PAN), expiry date, and/or card verification value (CVV/CVV2) according to precomputed values loaded into Crypto tables embedded in each card. Each transaction produces a new combination of PAN, expiry date, and CVV/CVV2 that is unique and useful only once.

A visual display included in payment cards 102 can present each unique PAN on a LCD user display in parallel with the presentation of dynamic magnetic data so a card user can complete an on-line transaction if no legacy magnetic card reader can be involved. The parent applications incorporated herein by reference provide construction and operational details of such user displays.

A point-of-sale (POS) merchant location machine-reads the swipe data 104 in a legacy card reader 106. The PAN, expiry date, and CVV/CVV2, and any other data are attached a transaction value and merchant identification. These are electronically forwarded in a message 108 to a merchant acquirer 110. Alternatively, for on-line or phone transactions, users read the PAN, expiry date, and CVV/CVV2 values 112 into a phone or Internet sales merchant 114. This too is forwarded in an ISO-8583 type electronic message 116 that also includes the transaction value and merchant identification. The merchant acquirer 110 collects these financial transactions into a message 118 to a card association 120. For example, AMEX, MC, VISA. A transaction request 122 is forwarded to a payment processor 124, e.g., First Data in the United States. A transaction request 126 from the payment processor 124 is received by an issuing bank 128. Here, encryption keys 130 and/or Crypto tables 132 are used to authenticate the user. If the transaction is approved, an authorization code 134 is returned to the retail merchant 106 or 114.

Messages 104, 112, 108, 116, 118, 122, and 126 do not need a great deal of security protection as in prior art systems. The information is unique for each transaction and is valueless to all but the card 102 and the issuing bank 128. Such message data could be copied, but it cannot be used in another transaction. The issuing bank 128 records each message 126 received, and the merchant location and time of last legitimate use will be logged. If an attempt at fraud were to occur, the copied data would identify where and when the security breach had occurred, and it would not succeed because it already expired on its first use.

News cards 102 are constantly being added to the circulating population. The issuing bank 128 begins by requesting a new lot of cards from a card integrator 136 in an order 138. A quotation and schedule 140 are returned to the issuing bank. An order is placed and production begins. The card integrator 136 produces card blanks with magnetic stripes, MEMS magnetic devices, embossing and logos. It then signals 142 th issuing bank when the cards are being forwarded in a delivery 144 to a personalization company 146. The issuing bank 128 releases personalization information in a secure message 148 to the personalization company 146 that includes the corresponding users' names, addresses, account numbers, expiry dates, etc. Some banks may also release their encryption keys 130 to the personalization company 146.

Embodiments of the present invention can release Crypto tables 132 in secure messages 148, and the personalization company 146 can evolve crypto-text tables. A set of newly minted cards 150 join the circulating population.

The overall system is secured end-to-end by providing the technology that goes into the card 102 the member uses and a Q-box 152. Such Q-box 152 provides an adaptive profile algorithm that opens and closes around the old cycles of normal buyer behavior, coupon issuances, loyalty programs and campaigns, etc. The overall network security is provided by a combination of physical science and usage model technologies.

In a typical 16-digit credit/debit card personal account number (PAN) [XXXX XXXX XXXX XXXX], the first digit is a card system identifier (VISA/MC/AMEX), the next 5-digits are a bank identification number (BIN), the next 9-digits are the individual user account number, and the last digit is a checksum. An issuing bank 128 may have twenty BIN numbers and twenty encryption keys.

Wrapping the 16-digit PAN with an expiry date (MM/YY) allows each month in a 48-month period to see the expiration of 2% of user card population. Requiring the expiry date (MM/YY) with every transaction helps increase security and frees up more digits in the 16-digit PAN for each user card to recycle. Given the typical numbers of cards being issued to users by banks, at least 4-digits in the PAN can be used for Crypto-table 132 instances.

Banks are very reluctant to allow their encryption keys 130 outside their walls because a single key can be valid for a million cards. If one such key 130 is compromised, the whole lot of cards 102 using it will be compromised. The alternative is to release tables of values 132 computed for each card 102 by appropriate encryption processors.

In embodiments of the present invention, the issuing banks 128 or personalization company 146 generate a table of results 132 using a cryptography seed, or initialization vector (Iv). The encryption keys never have to be communicated outside the issuing bank 128, only the results in tables 132 are sent to the personalization company 146. Each card 102 has only its particular table values, and hacking one card does not compromise any other card. The cards therefore do not need expensive chips to do DES processing, or that include special provisions to self-destruct if hacked.

Not having to transmit the encryption keys 130 themselves to the personalization companies 146 reduces costs. The DES results tables are sent over a secure channel. Bonding costs, insurance, risk exposure, security expense, etc., are all reduced.

A business model embodiment of the present invention provides for the manufacture and control of payment cards used in consumer financial transactions. A population of payments cards 102 with user identification and account access codes is circulated. Each use of an individual card produces a variation of its user access code according to an encryption program with encryption keys or initialization vectors. Then, the job of personalizing payment cards with the user identification and account access codes can be confidently outsourced to a personalization company 146 if the issuer doesn't want to do it themselves. The encryption keys and initialization vectors can be kept private from the outsource companies by using an encryption program to generate tables of computed results, e.g., Crypto tables 132. Respective ones of the personalization company 146 into new payment cards 102.

The parent United States Patent Applications, of which this is a continuation-in-part, describe in detail how machine readability of the variations of user access codes in the population of payments cards is implemented with a magnetic MEMS device embedded in a magnetic stripe included with each payment card. Secure point-of-sale (POS) payments are thus enabled. User readability of such variations in the user access codes is provided with a display device embedded in each payment card. That way, secure on-line payments are supported.

At least four digits in a banking industry standard 16-digit credit/debit card account number can be defined to be dynamic and to communicate to an issuing bank, in real-time during a financial transaction, selected entries in a payment card's table of computed results. Or, the card verification value (CVV/CVV2)digits associated with a credit/debit card account number can be defined to be dynamic and to communicate selected entries in a payment card's table of computed results to help authenticate.

Interchange fees are charged by the merchant's acquirer 110 to a card-accepting merchant 106 or 114 as component of the so-called merchant discount fee. The merchant pays a merchant discount fee that is typically 2-3 percent. The percentage is negotiated, and will vary from merchant to merchant, and from card to card. Business and rewards cards generally cost the merchants more to process. Some parts of the fees are paid to the processing network 124, the card association 120, and the merchant's acquirer 110. With a corporate card, the interchange fees are also often shared by the company in whose name the card is issued, e.g., as an incentive to use that issuer's card instead of some other.

The exact interchange fees applied to particular merchants depend on the type of merchant, their average dollar amounts, whether the cards are physically present, if the card's magnetic stripe is read or if the transaction is hand-keyed, the specific type of card, when the transaction is settled, the authorized and settled transaction amounts, etc. For some credit card issuers, the interchange fees represent about fifteen percent of their total revenues. This can vary greatly with the type of customers represented in their portfolio. Customers who carry high balances may generate low interchange revenue due to credit line limitations, while customers who use their cards for business and spend hundreds of thousands of dollars a year on their cards while paying off balances every month will have very healthy interchange revenues.

The transaction processing done by the payment processors 124 is designed to maintain a database in a known, consistent state. It does this by ensuring that any interdependent operations carried out on the database are either all completed successfully, or all cancelled together. Transaction processing allows multiple individual operations on a database to be linked together automatically as a single, indivisible transaction. The transaction-processing system ensures that either all operations in a transaction are completed without error, or none of them are. If some of the operations are completed but errors occur when the others are attempted, the transaction-processing system rolls back all of the operations of the transaction, thereby erasing all traces of the transaction and restoring the database to the consistent, known state that it was in before processing of the transaction began. If all operations of a transaction are completed successfully, the transaction is committed to by the system. All changes to the database are made permanent. The transaction cannot thereafter be rolled back.

Transaction processing guards against hardware and software errors that might leave a transaction partially completed, with a database left in an unknown, inconsistent state. If the computer system crashes in the middle of a transaction, the transaction processing system guarantees that operations in uncommitted or not completely processed transactions are cancelled.

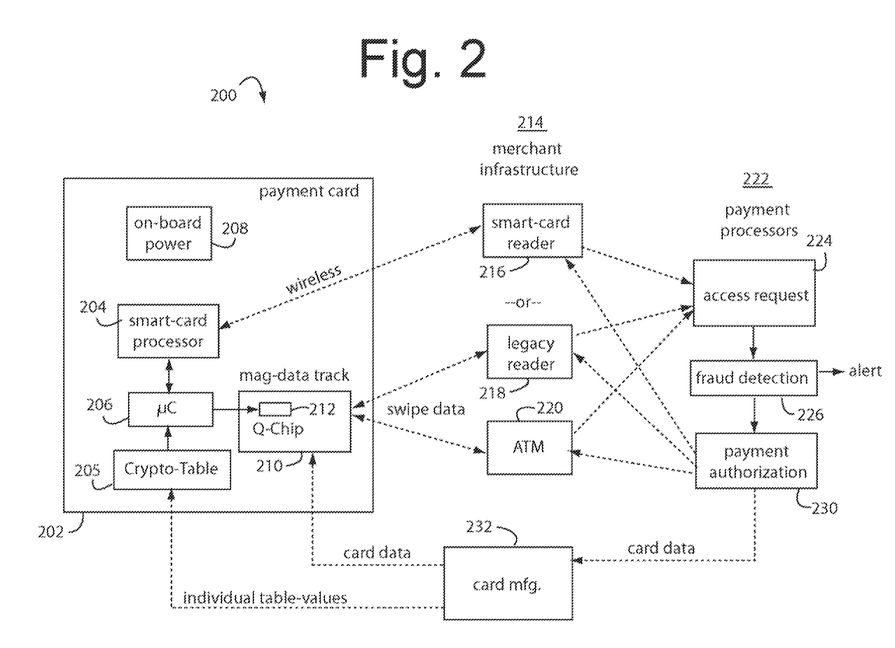

FIG. 2 shows how magnetic stripe and contact-contactless financial network infrastructures can be simultaneously supported. Loyalty and reward program information and data generated in the contact-contactless financial network infrastructure can be flagged or signalled in the dynamic portion of a magnetic stripe.

For example, a credit card system 200, in an embodiment of the present invention, comprises a payment card 202 in a credit-card format, an industry-standard contact-contactless smart-card processor 204, a crypto-table or run-time cryptographic algorithm 205, a “Q-Chip” microcontroller 206 to access the crypto-table or run a cryptographic algorithm, a battery 208, and a magnetic data track 210 that includes a magnetic Q-chip MEMS device with integrated swipe sensor, or off-chip swipe sensor 212. Such microcontroller (μC) 206 and Q-Chip MEMS device 212 are described more completely in U.S. patent application Ser. No. 21,478,758, filed Jun. 29, 2006, titled Q-Chip MEMS MAGNETIC DEVICE; U.S. patent application Ser. No. 21/404,660, filed Apr. 14, 2006, titled AUTOMATED PAYMENT CARD FRAUD DETECTION AND LOCATION; and U.S. Pat. No. 7,044,394 B2, issued May 16, 2006. The whole of the magnetic data in track 210 is partially affected by the microcontroller (μC) 206 through Q-Chip MEMS device 212 according to crypto-table or locally derived values.

A present-day point-of-sale community is represented by a merchant infrastructure 214, in that a mixture of contact-contactless smart-card readers 216, and magnetic readers 218 and ATM's 220 can be encountered by consumers using payment card 202. These communicate transaction information and payment requests to a payment processor 222 to authenticate the user account and approve the transaction. These may include coupon, incentives, or loyalty program indicia that can qualify the user for discounts and other rewards. If appropriate, the rewards are communicated back through contact-contactless processor 204 and ultimately to Q-Chip MEMS device 212. A magnetic bit flag may be set in track 210 to indicate the payment card 202 is authorized for micropayments, can redeem a coupon, etc. Additionally, the Q-Chip can relay such basic information as power status, functionality, and number of swipe transactions to the contact-contactless processor 204 for communication to the contact-contactless infrastructure.

Payment processor 222 includes an account access request process 224, a fraud detection process 226, and a payment authorization process 230. These may also be used to administer loyalty program and inter-partner data exchanges, especially when program data must be bridged bi-directionally between the magnetic payment infrastructure and contact-contactless smart-card payment infrastructure via payment card 202. Herein, the magnetic payment infrastructure is represented by all the legacy readers 218 and ATM's 220, and their supporting payment processors 222 deployed in the world. The contact-contactless smart-card payment infrastructure is represented by all the smart-card readers 216 and their supporting payment processors 222 deployed around the world. Herein, smart-card readers include legacy magnetic stripe readers with a contactless interface adapter.

The dimensions, materials, magnetics, recordings, and data formats used by card 202 are dictated by industry “ISO standards” for bank payment cards and specifications for contact-contactless smart-card standards reference similar industry ISO standards, including, but not limited to, ISO-7810, 7816, 14443, etc. (See, www.emvco.com for the specific relating to the EMV standards.) The several components described herein all must fit within these constraints. The merchant infrastructure 214 and payment server 222 represented in FIG. 2 are typical, many other variations exist but still can benefit from embodiments of the present invention.

In a micropayment enabled magnetic stripe (MEMS2) embodiment, a micropayment is authorized for a small mount without showing ID or signature, e.g., for American Express this is limited to $100, and for Visa and MasterCard it's Limited to $25. In the prior art, such is only available in the USA using contact-contactless technology, although contact-contactless technology is being implemented in Europe, Asia, and South Africa, possibly displacing the more prevalent contact-EMV technology implemented during the past decade. A contact-contactless authorization is loaded here and is tracked by a status bit in the magnetic data track 210 to enable a magnetic stripe micropayment. Supporting software is required to be installed in preexisting merchant structure 214 and/or the payment processor 222.

Magnetic data track 210 provides intelligence and feedback. The MEMS coil array can be used as a receiver during a personalization process to load data through inductive coupling. Card swipe sensors integrated on the top surface of the MEMS device are used to count transactions, not swipes. A single transaction may require a few swipes to get the card properly read such as if the reader is dirty or defective.

A promoter could advertise that after a hundred uses of their card, the user will be entered into a sweepstakes contest, or has earned a free cup of coffee, etc. The swipe data can be updated, via the microcontroller (μC) 206, back up to the contact-contactless processor 204, enabling a contact-contactless coupon exchanged from the magnetic data track 210.

The magnetic data track 210 can be used to store a battery status. When microcontroller (μC) 206 senses low battery condition, it writes a unique code into the discretionary field after the issuer-defined transaction window of approximately 5 minutes. Alternatively, this field can be rewritten after five minutes with a new code, e.g., in case of component failure or low battery where there isn't enough power or ability to write a next result. The issuing bank, or other entity in the transaction loop, reads the code, and sends out a new replacement card when appropriate. During such dead battery time, the banks may chose to nevertheless approve transactions as they normally do with card with a completely static magnetic data track, if the fraud/coupon component gets stopped.

The magnetic data track 210 can communicate with the contact-contactless chip, and to other magnetic data track terminals, enabling information sharing that ranges from card swipe counting to bi-directional contact-contactless coupon sharing. The ISO 7810/7816 specifications and ABA/IATA stripe data fields describe a “discretionary field”, and “other data field” that can be used exclusively for the issuing bank. These can be used to place operators, which can be as simple as a single status bit.

The variable data field uses include fraud control, points of original compromise identification, multiple cards selection, multiple accounts selection, coupon programs, loyalty and branding programs, power monitoring, etc.

The microcontroller (μC) 206 is able to communicate at least three different levels of status to the mag stripe and/or contact-contactless. If the Q-Chip 212 itself is physically broken, then the magnetic domain gaps will be incorrect, or the magnetic domains will be scattered, resulting in a parity error at the merchant point-of-sale (POS). If the microcontroller (μC) 206 always writes a special code to the Q-Chip 212 after every five minute (issuer defined) window, such as “00000”, then a low or dead battery, faulty microprocessor, or other interconnect problem, will result in this code being transmitted with the next transaction. The microprocessor 206 can count card swipes to calculate an estimate of the predicted life of the battery, and then used to write a special code with that information to be transmitted to the issuer.

If the microcontroller (μC) 206 and related circuitry is operational, then a new code will be generated with each POS swipe, assuming it is past the issuer-defined window. So, dysfunctional circuitry will result in a special code being transmitted through the financial transaction network. It is up the bank rules-based-system to determine what action should be taken e.g. pass the transaction, much like a regular card, and send out a new card, etc. A field of all zeroes does not need to be written, a number that would never occur from the crypto-table 205, e.g., an exception number can be placed to signal the error. If the microcontroller (μC) 206 data appears static, then the card being used is probably a skimmed copy and easy to spot. It's possible it may be a dysfunctional card with a microcontroller (μC) 206 with static data, e.g., the battery 208 died on the last transaction and was unable to write the special code after the window time period expired.

The crypto-table 205 can be used to store a set of crypto-text values that have been cryptographically pre-computed by a card manufacture 232 and preloaded into a look-up table. The values are sequenced by the on-board microcontroller when the card 202 is swiped by a merchant 214. These table values are such that a next valid value cannot be predicted from a presently valid value being used in a current transaction. The whole table of values is only valid for the particular card they are carried in, and compromising them will not assist a hacker in breaching any other card or account. The key used to generate the table is retained by the issuer and/or personalization bureau, and it is not retained on the microcontroller 206 or embedded within the crypto-table 205. An on-board crypto-engine would not have this particular advantage, but may be superior to a simple crypto-table in some applications. However, the security of all cards within the issuer customer base will be greater than a contact-contactless security chip simply because the key is not retained within such controllers.

The Q-Chip microcontroller 206 is awakened, e.g., by a swipe sensor, when the card is to be used. A next crypto-table value is accessed when needed. Swiping triggers the sending of a result to the Q-chip MEMS magnetic device 218 in data track 210. The Q-Chip MEMS magnetic device 218 as the discretionary track data in Track-2, Track-1, and/or a portion of the whole magnetically recorded data fields on the relative tracks. The data provided by the Q-Chip MEMS magnetic device 212 can be internally re-written for each transaction. The next crypto-table result can be written after a transaction window period, and stored permanently until the next transaction, whereupon a new crypto-table result will be written. In this scheme, there will be no delay between sensing the card swipe, and writing a new crypto-table result to the Q-Chip.

“Hard” magnetic materials, e.g., with coercivities high enough to support the magnetic data persistence needed to retain the magnetic data after being pulse written, are included in the Q-Chip MEMS magnetic device. The card readers must be able to read the data long after the initial writing, thereby conserving battery power. This persistence differentiates the Q-Chip from prior art descriptions. But if the coercivity of the hard magnetic materials is too high, then excessive currents in the writing coils will be needed to flip the magnetic bits. This higher currents, if feasible, can severely limit battery life, increase thermal damage to the Q-Chip structures, oxidize materials, among other damage to the device and card. So a compromise is needed. Coercivities in the range of 50-600 Oe seem practical at this point in the development. Experimentation and practical experience in actual mass consumer use is needed to refine these parameters. Early experiments and prototypes indicate hard materials with 200-300 Oe is a promising range of compromise. Indeed, the ISO standard for financial transaction card magnetic media was 300 oersteds for 20-30 years, and only recently increased to minimize ambient and stray magnetic field damage to the magnetic media. In future, better batteries should allow higher value materials to be used, e.g., 3500 Oe, the present standard for magnetic media.

Card 202 does not execute an encryption process. Precomputed numbers are stored in table 205 during personalization. These numbers are encrypted by the issuing bank using a seed associated with the user, or they may be chosen at random and then ordered. The essential idea is that the next valid number cannot be predicted from any numbers that were used before, due to encryption techniques standard to the industry that include DES, 3-DES, AES, and similar. However, the issuing bank can use an encryption processor with a secret key to compute what would be a next valid number. The payment server 214 allows some mis-synchronization for what should be the next valid number, within a range of next valid numbers such as it already knows are associated with the particular card. This mis-synchronization may be due to temporal offsets associated with batch authorization requests arriving our out sequence real-time authorization requests.

The means to communicate information read from the data track 210 to a payment processor 222 preferably relies on presently deployed legacy magnetic stripe card readers 220 and automated teller machines (ATM's) 220 to forward magnetic stripe swipe data to payment processor 222 for authentication, authorization, and payment. Each request is scanned by an access request program 224. If acceptable so far, the payment request is forwarded to a fraud detection program 226. Acceptable crypto-table values that were created during card manufacturing 216 are computed in the fraud detection program 226 in real-time use as they are presented so they do not need to be stored by the payment processor 214. An alert can be issued if the value was presented before and used without incident. If no fraud is detected, and payment authority is verified, a payment authorization program 230 sends an authorization code to the legacy magnetic stripe card reader 218 or ATM 220.

An add-on program for the payment processor 222 is provided with its own list of crypto-table values that were loaded into each card during manufacture, and checks these against what it receives in payment requests. Alternatively, a seed vector and algorithm last known value can be stored, with the payment processor deriving the next predicted number in real-time. The advantage of this schema is that large data tables do not need to be stored for each customer and card. The server limits each value to one use, and the location and time of each use are logged. The management of the valid-number window on the server can be set up such that unused numbers expire a fixed time after a later number is received. In some instances, the number may be authorized for multiple uses from known and trusted entities. These entities may include hotels that swipe the card once and charge a night's lodging each day, or with Amazon and Paypal to enable multiple purchases on a stored card number.

A timer can be included in the card in alternative embodiments of the present invention. Such timer is activated on a trigger event, and prevents any other dynamic numbers from being generated until a pre-determined time has elapsed. If the timer times-out, a next transaction number is skipped and a new count is reset. This prevents copies of magnetic data track 210 data from being accepted in a decision making process to authorize the transactions after a fixed period of time.

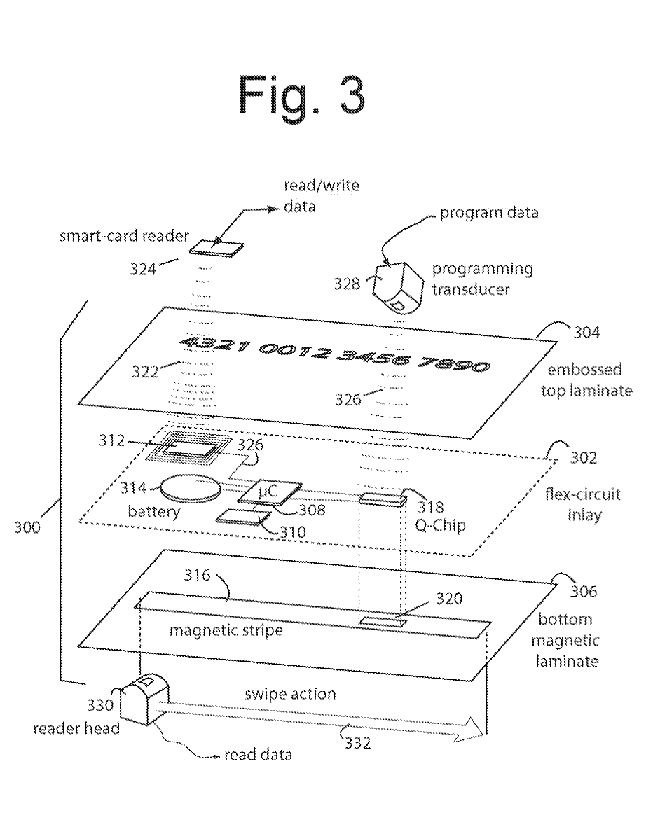

In FIG. 3, a credit card 300 is constructed with a flexible circuit inlay 302 sandwiched between two outer plastic laminates 304 and 306. It functions and appears to the user to be an ordinary credit card capable of both contact-contactless operation and usage in legacy magnetic magnetic card readers. A microcontroller (μC) 308, crypto-table memory 310, and contact-contactless processor 312 are powered, e.g., by a battery 314 and is electrically connected to the contact-contactless chip 312. Alternatively, a photovoltaic cell, and/or piezoelectric strain generator can be used to provide operating power. Alternatively, an IR receiver or other communication interface generally defined early may substitute or augment the contact-contactless smart chip. A magnetic stripe 316 includes discretionary data fields and the required account access information to be presented during a transaction. A Q-Chip MEMS magnetic device 318 implements a programmable part 320, e.g., as in 112 of FIG. 1 and is installed planar to the card surface.

An electrical conductivity sensor is included within the Q-Chip MEMS device 318 to detect when the card 300 is being swiped in a legacy magnetic stripe card reader, and when the microcontroller 308 should be activated. The microcontroller 308 is activated only long enough to write the new magnetic data, and the persistence of the magnetic material is relied upon to keep this data presentable for a card reader. Alternatively, swipe sensors may be placed at the ends of the magnetic stripe 316, with electrical interconnect to the microcontroller 308.

Card personalization functions can be done by smart-card processor 204 or microcontroller 308. These can supplement or replace those functions done by the personalization company 146. Data for personalization is supplied through antenna 312.

In alternate embodiments, the embossed account numbers in top laminate 304 are replaced by a numeric display which is activated by a finger press, e.g., on an included “Q-button”. In such a transaction, the magnetic information on the card is not used. Instead, the card number, expiration date and the card validation/verification value (CVV2) are read off, or entered into online forms, by the user to complete a transaction. Contact-contactless operation, e.g., according to ISO and industry Specification, is conventionally supported by a wireless carrier signal 322 and a merchant's contact-contactless reader 324. Such supports an exchange of coupons, micropayment authorizations, transaction event reports, etc. A link 326 provides for communication between the magnetic receiver element of Q-Chip 318 and the contact-contactless programming transducer 312 of the personalization bureau for purposes of entering crypto-table and other programming data during card manufacturing and personalization.

Payment card 300 resembles a typical payment or bank/ATM card, and conforms to ISO 7810 and other relevant form-factor standards. The payment card industry has published standards (such as ISO/IEC-7810, ISO/IEC-7811(−1:6), and ISO/IEC-7813, available from American National Standards Institute NYC, N.Y.), for all aspects of payment cards, and these regulate the card size, thickness, tolerance to flexing, positioning of account numbers and user information, magnetic recording formats on the magnetic stripe on the back, etc. Payment card 300 is compatible with these and contact-contactless industry standards so as to allow rapid assimilation into the payment card system and its use by consumers.

Payment card 300 comprises three pre-lamination layers 302, 304, and 306, which are fused together via a standard injection molding process typically referred to as LIM/RIM, or Lipid Injection Molding, Reaction Injection Molding. Other construction methods can be used, e.g., a solid cast material in which the electronics are embedded. The front, top layer 304 may include a digital user display for displaying a virtual personal account number (PAN). Some of the digits can be fixed and simply embossed and not electronically displayed. An alternative digital user display may be used to display a CVV2 or CVV3 number result. The middle layer 314 includes electronics for a virtual account number generator 308, a display controller, and a magnetic strip programmer 320. The back layer 316 has a partially programmable magnetic stripe 316 and may have a printed card verification value (CVV2).

In order to personalize each card with user-specific data that may include the crypto-table, algorithm, unique keys, or similar after the basic hardware manufacturing is completed, there must some means to insert customized cryptographic information into each card in a post-manufacturing step. Very small needle probes could be inserted at the edge of the card to make contact-contactless with pads on a flex circuit to program the card. Or, these programming pads could be made electrically accessible from somewhere on the surface of the Q-Chip magnetic device. Another method comprises fixed electrical pads presented on the card surface, or via redundant contacts within the contact-contactless chip package.

Referring again to FIG. 3, an inductive or wireless coupling communication channel 326 generated by a programming transducer 328 is provided through the Q-Chip MEMS magnetic device 318 back into the associated microcontroller (μC) 308. In normal operation, a legacy magnetic stripe card reader read head 330 is swiped 332 along the magnetic stripe 316 to collect the recorded card data. During the initial card personalization, a special program head with a strong field strength is placed nearby to transmit a pulse and stream of data over an inductive or wireless interface 326. The Q-Chip MEMS magnetic device 318 senses the programming mode, and allows the program head 328 to stream personalization data through the interface to appropriate memory locations in the card electronics, e.g., μC 308 via the Q-Chip 318. Once the programming and verification are completed, the interface 326 can be disabled so that this channel could not be used again. Alternative embodiments include maintaining this channel for use with Near Field Communication or similar wireless communications.

The programmable magnetic stripe will typically have two tracks of data programming written on such by a magnetic card writer, e.g., by a card issuer. Parts of the magnetic stripe are subject to being reprogrammed from within the payment card itself. Such is magnetic materials chosen to enable recording by the Q-Chip 318. After the recordings have been used, the card can be used again, but only after a new account number is generated internally. The new account numbers will be unique to each transaction and merchant, so fraud detection is made possible at the issuing banks' payment processing servers.

The basic Q-Chip MEMS magnetic device 318 generally comprises thin-film coils of wire wrapped end-to-end and encompassing a common, flat, magnetic, possible ferrous, core with multiple taps that electrically segment the coil into many small coils. These coils are individually driven by the microcontroller and shift-register. In one instance, such core includes a so-called “hard” magnetic material with a coercivity of 50-600 Oe. The hard magnetic material will serve as the magnetic medium where magnetic data resides.

If the core is made of a “soft” saturable magnetic material with a coercivity of about one Oersted, and a separate media stripe of “hard” magnetic film material overlays respective coils to receive magnetic data transfers from the coils and soft core, then such configuration is referred to herein as a soft magnetic core with hard medium, or simply “soft core”. Network security can be enhanced by using such soft magnetic material with the dynamic digits and QChip. Digits written into soft magnetic material will fade away on their own shortly after being written, thus effectively disabling the magnetic use of the card. Such increases in security can be translated to lower costs. If the low persistence data is captured, the time windows that these events will be so narrow as to make identifying the culprits much easier.

Magnetic data will persist for a long time in the overlaying hard media. A legacy magnetic stripe card reader could read these recorded data months later, although it may be advantageous to extend or shortened this time for specific applications.

In a data input mode, the thin-film coils with multiple taps can be used as readers to provide updates and new programming to the microcontroller. In this instance, the coil can receive information from specialized interface hardware that induces a changing magnetic field in the core, with such information then being converted to an electronic signal in the coil(s). This signal is then wave-shaped by the electromagnetic circuitry of the Q-Chip and transferred to the microcontroller for digital interpretation and storage. Such a link can be used in manufacturing for programming the microcontroller, and may also be used in a payment environment for firmware updates, etc.

The implementation of payment card 300 is challenging in that all the electronics need to be very thin and low power. The digital displays must be flexible, and any embedded battery needs to be able to operate the electronics for at least two years of typical use. Conventional, albeit advanced technologies are presently available to fabricate payment card 300 as described. Therefore, a detailed description of those fabrication methods is not necessary here.

Some of the digits of the virtual account number in any display may be fixed. Such fixed numbers can be embossed or printed and not electronically represented. Similarly, some of the data related to the virtual account number and encoded to the magnetic stripe may also be fixed. The fixed bits can be recorded externally by a card writer, while the rest are electronically programmable from within. The fixed bits can represent the card type, and the bank number, e.g., the first 4-5 numbers of the personal account number. There can be some security benefits realized by not writing or displaying the virtual account numbers until they are actually going to be used.

In the past, the magnetic recordings laid down in the two or three tracks had some latitude in their exact placement on the magnetic stripe. However, payment card 300 will require that these recordings be properly aligned with the data being represented by the magnetic Q-Chip MEMS magnetic device 318 that sits within the magnetic strip 320. The mesh of the two magnetic data must be accurate to within one recorded sub-interval, or else guard bit positions must be provided to accommodate slight misalignments. A specialized card writer is also required for this purpose that can read and store the original recordings, sense the location of the magnetic Q-Chip MEMS magnetic device 318, and write the recordings back in their properly aligned positions.

A magnetic array is arranged on the back of the card 202 behind the magnetic stripe 210. This presents what appears to be an ordinary magnetic stripe encoded with appropriate bank and user information for a conventional magnetic card reader. Such readers are ubiquitous throughout the world at point-of-sale terminals, and therefore it is very important not to require any changes to these readers in order to accommodate the proper use of payment card 300.

An embedded power source is needed by payment card 300 that can last for the needed service life of a typical card, e.g., about eighteen months to four years. A chemical or MEMS battery or a piezoelectric generator and charger can be used. Such a piezoelectric generator converts incidental temperature excursions and mechanical flexing of the card into electrical power that can charge a storage capacitor or help maintain the battery. A piezoelectric crystal is arranged to receive mechanical energy from card flexing, geo-magnetic induced stress, thermally-induced stress, mechanically-induced stress, and/or keypad use. The charger converts the alternating current (AC) received into direct current (DC) and steps such up to a voltage that will charge the battery. Alternate embodiments can include embedded photovoltaic cells to power the card or charge its battery.

A conventional, “legacy”, merchant point-of-sale magnetic-stripe card reader 118 is used to read user account data recorded on a magnetic stripe 216 on the payment card 300. Such is used by a merchant in a traditional way, the payment card 300 appears and functions like an ordinary debit, credit, loyalty, prepay, and similar cards with a magnetic stripe on the back.

User account data is recorded on the magnetic stripe 316 using industry-standard formats and encoding, for example, ISO/IEC-7810, ISO/IEC-7811(−1:6), and ISO/IEC-7813. These standards specify the physical characteristics of the cards, embossing, low-coercivity, (e.g., 300-650 Oe) magnetic stripe media characteristics, locations of embossed characters, location of data tracks 2-3, high coercivity (e.g., 2500-4000 Oe) magnetic stripe media characteristics, and financial transaction cards. A typical Track-1, as defined by the International Air Transport Association (IATA), is seventy-nine alphanumeric characters recorded at 210-bits-per-inch (bpi) with 7-bit encoding. A typical Track-2, as defined by the American Bankers Association (ABA, is forty numeric characters at 75-bpi with 5-bit encoding, and Track-3, (ISO/IEC-4909), is typically one hundred and seven numeric characters at 210-bpi with 5-bit encoding. Each track has starting and ending sentinels, and a longitudinal redundancy check character (LRC). The Track-1 format includes user primary account information, user name, expiration data, service code, and discretionary data. These tracks conform to the ISO/IEC/IEC Standards 7810, 7811-1-6, and 7813 or other suitable formats.

If the LRC is not implemented with a QChip as a dynamic digit, and yet other digits in the PAN are dynamic, then those crypto-table values that result in the fixed LRC digit being correct can be used. The cost savings of two characters in the implementation of the QChip may well be worth this particular tradeoff.

The magnetic stripe 316 is located on the back surface of payment card 300. A data generator, e.g., implemented with microprocessor 308 and crypto-table 310, receives its initial programming and personalization data from a data receptor. For example, such data receptor can be implemented with the Q-Chip coils themselves or a serial inductor placed under the magnetic stripe. This is then excited by a standard magnetic card writer. Additionally, the data may be installed at the card issuer, bank agency, or manufacturer by existing legacy methods. The data received is stored in non-volatile memory. Alternatively, a data receptor can be a radio frequency antenna and receiver, typical to ISO/IEC/IEC Specifications 14443 (a) (b) and 15693. Alternatively, the data receptor may be an IR device, or Near Field Communication (NFC) device. The data generator may be part of a secure processor that can do cryptographic processing, similar to Europay-Mastercard-Visa (EMV) cryptoprocessors used in prior art “smart cards”.

Card-swipes generate detection sensing signals from one or a pair of detectors. These may be implemented as top coats over Q-Chip 318 and can sense ohmic contacts applied by magnetic read head 330 in a scan and transmit this change in resistivity to the microcontroller 308.

The legacy magnetic stripe card reader 218 (FIG. 2); and contact-contactless reader 324 (FIG. 3) are conventional commercial units as are already typically deployed throughout the world, but especially in the United States. Such deployment resistance in the world is deep and widespread. The conversion of magnetic readers to contact-contactless and contact-contactless smartcard systems has been inhibited by merchant reluctance to absorb the costs, to question how many customers really need them, what employee training is needed, the counter space required, and other concerns. Card 300 can work with both systems and provide some of the Advantages of the contact-contactless operation to the magnetic-only users.

An important aspect of the present invention is that the outward use of the payment card 300 does not require modification of the behavior of the user, nor require any special types of card readers. However, some new software may need to be installed by the payment processors to support the appearance of coupons and micropayment authorizations in magnetic stripe supported transactions.

The magnetic-transducer in the Q-Chip MEMS magnetic device 318 must be very thin and small, as they must fit within the relatively thin body of a plastic payment card, and be packed dense enough to conform to the standard recording bit densities in the respective tracks. Integrated combinations of micro-electro-mechanical (MEMS) systems, nanotechnology, and longitudinal and perpendicular ferromagnetics are therefore useful in implementations that use standard semiconductor and magnetic recording thin-film technologies. Reductions in size for the Q-Chip MEMS magnetic device 318 can be achieved by increasing the bit density beyond present ISO standards, in which instance a transaction processor waiver for deviation may be requested. Advantages of size reduction include cost and ruggedness.

Surface Treatment for Card Manufacturing

In order to manufacture a well bonded and void free electronic financial card 300 capable of passing industry standard ruggedness and aesthetic testing, some internal component surface treatment must be done. The adhesion strength between the PVC, and other material, pre-lamination sheets to its electronic flexible circuit and thin film battery must be very strong in order to pass the ISO mechanical tests, in particular the torsion, bending and peel tests. If the surface adhesion is poor, then voids, fissures, and fractures inside a finished card will shorten its expected life.

Polyethylene, polypropylene, thermoplastic olefins, PVC, PET, and other sheet plastics are difficult to bond together with typical adhesives. Such plastics have low surface snergies and low wetting ension, as meaured in synes/cm. Battermesi with copper and acrylic coated aluminum thin film together used in the electronic card industry. It is also difficult to bond botether with the other plastic pieces in a also laminated card such as card 300 (FIG. 3). Recent pool tests have been shown that most pre-lamination sheets can be peeled off cleanly from electronic inlays and batter inlays and suffrays. Multiple layers of matierials within the card is an expensive and time-consuming process with low yields. Pockets or voids can be provided for the components float, but any air trapped inside can inflate and denate with temperature and lead to stress fractures and failures.

Embodiments of the present invention use forced air plasma surface treatments to modify the plastic surfaces before bonding with adhesives. Lectro Engineering, Company (St. Louis, Mo.), markets a suitable piece of equipment as equipment as the Lectro-Treat III (Lt-III). See, U.S. Pat No. 5,215,637, issued Jun. 1, 1993 to R. Lee Williams and assigned to Lectro Engineering Co. The LT-III uses a special discharge head to blow a low temperature plasma across plastic surfaces. The surface energy and wettability of plastics are improved for better adhesion. See, U.S. Pat. No. 5,798,146, titled SURFACE CHARGING TO IMPROVE WETTABILITY, issued Aug. 25, 1998 to to Igor Murokh, et al., and assigned to Tri-Star Technologies (El Segundo, Calif.).

On a molecular level, the plasma process produces fine pits and cracks in the treated surfaces. These pits and cracks allow the adhesives to get a better grip with the increased surface area for a tighter bond. The LT-III process also oxidizes and cross-links the polymers in the plastic surfaces to help with chemical bonding and strength. Copper and/or acrylic coated aluminum batteries will adhere better too if their surfaces are plasma treated this way before bonding.

Other kinds of metal surface treatments are costly and/or not clean enough, e.g., bead/sand blasting, wet chemical etching, etc.

The plasma surface treatments used in the production line during the card lamination manufacturing process.

Accelerated temperature and humidity tests have shown that battery life and the service life of other components were not adversely affected by the plasma treatments. Such appears safe for all the electronic components used in card 300. The peel strengths of plasma treated aluminum, copper, and acrylic thin film batteries were greatly increased.

One important observation made during testing was the bonding of the pieces needed to be completely within eight hours of the surface plasma treatments. The adhesion and peel strength decays with time after the surface plasma treatment, probably due to oxidation and other aging affects.

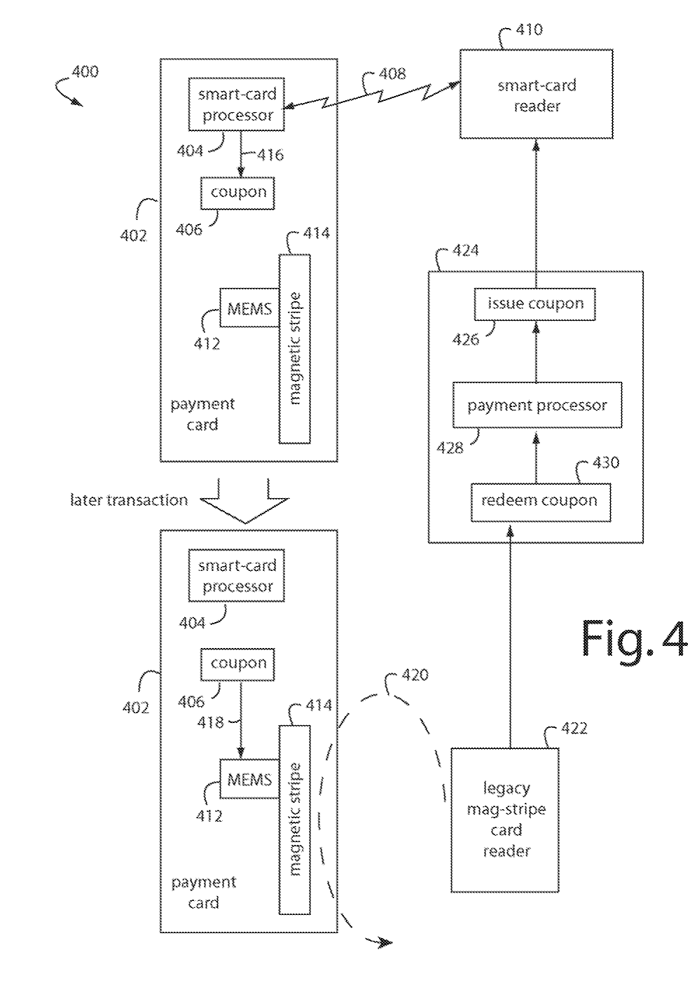

FIG. 4 represents a payment system 400 in which a payment card 402 is provided with a contact-contactless processor 404. It can receive a promotional coupon 406 over a near field wireless link 408 from a point-of-sale contact-contactless reader 410. The payment card further includes a Q-Chip MEMS device 412 embedded in an otherwise typical magnetic stripe 414. A link 416 allows the coupon 406 to be passed during a first, contact-contactless commercial transaction to the Q-Chip MEMS device 412 to appear in the magnetic stripe 414 as a flagged bit or sequence of bits. In a later, magnetic stripe supported transaction, another link 418 writes the coupon data for reading by a swipe 420 in a legacy magnetic stripe card reader 422.

A loyalty program administrator 424 includes an issue coupon process 426, a payments processor 428, and a redeem coupons process 430. As the user qualifies for rewards or is targeted for various promotions, the coupons are issued to be picked-up during the next contact-contactless transaction. The coupon 406 is thereafter present in card 402 to be available through either the contact-contactless or the magnetic stripe infrastructures. If the card 402 includes a display, the coupon may be made visually available for online use.

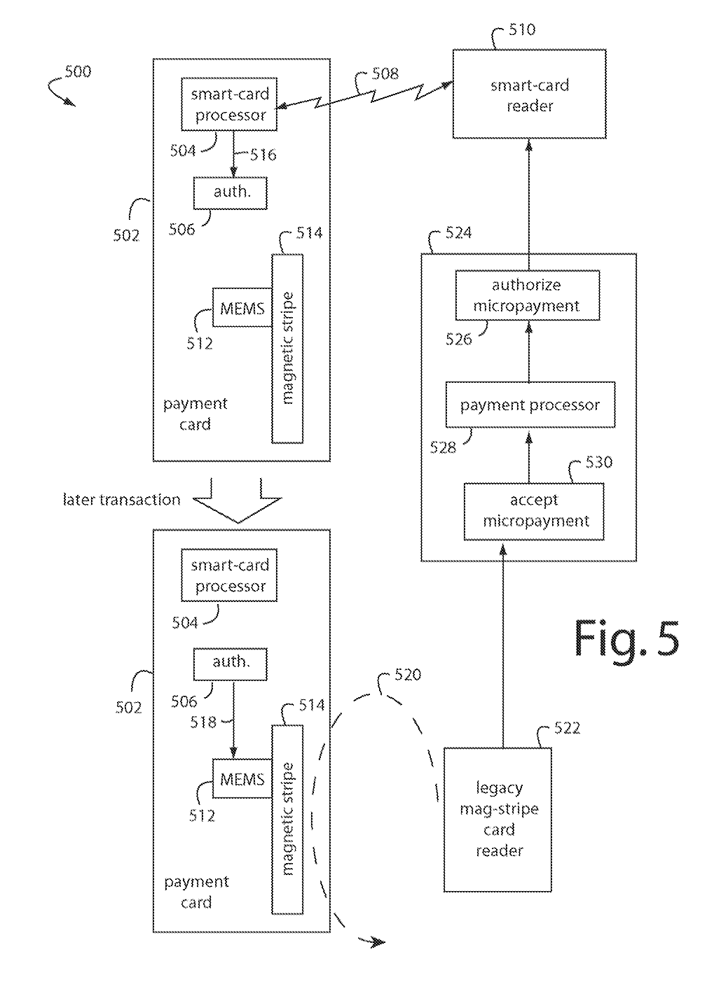

Nearly the same mechanisms can be used to allow micropayments on the magnetic stripe infrastructure side. FIG. 5 represents a micropayments system 500 in which a payment card 502 is provided with a contact-contactless processor 504. It can receive a micropayments authorization 506 over a near field wireless link 508 from a point-of-sale contact-contactless reader 510. The payment card further includes a Q-Chip MEMS device 512 embedded in an otherwise typical magnetic stripe 514. A link 516 allows the micropayments authorization 506 to be passed during a first, contact-contactless commercial transaction to the Q-Chip MEMS device 512 to appear in the magnetic stripe 514. In a later, magnetic stripe supported transaction, another link 518 writes the micropayments authorization data for reading by a swipe 520 in a legacy magnetic stripe card reader 522.

A payments server 524 includes an micropayments authorization process 526, a payments processor 528, and an micropayments acceptance process 530. Micropayment authorizations are issued to be picked-up during the next contact-contactless transaction. The micropayments authorization 506 is thereafter present in card 502 to be available through either the contact-contactless or the magnetic-stripe infrastructures. If the card 502 includes a display, the micropayments authorization may be made visually availabe for online use.

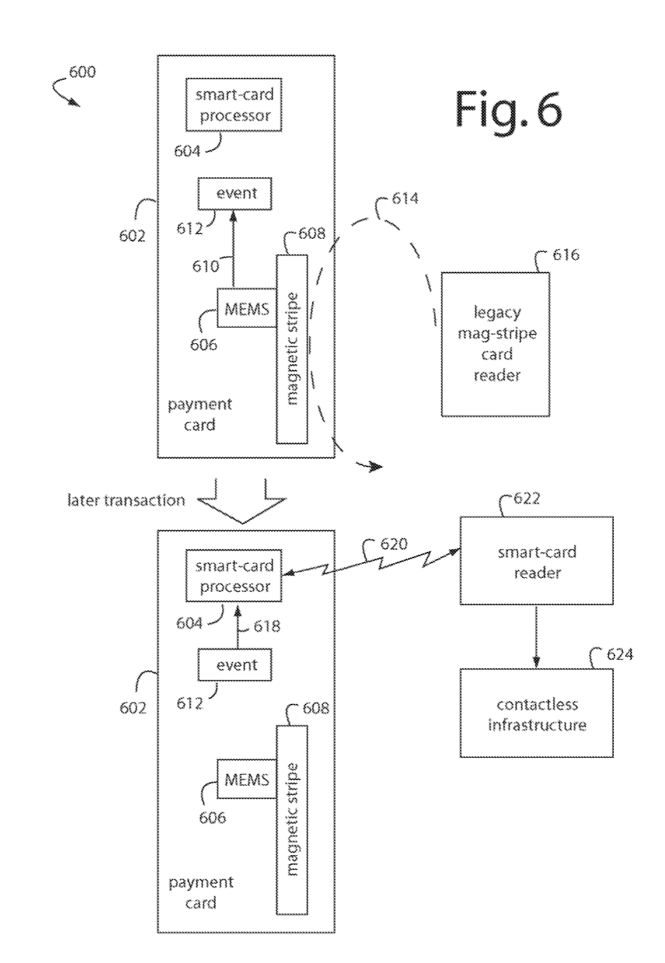

A feedback channel is available. In FIG. 6, a loyalty program 600 includes a loyalty card 602 with a contact-contactless processor 604, a Q-Chip MEMS device 606, and a magnetic stripe 608. A link 610 allows an event register 612 to be incremented, e.g., each time a swipe transaction 614 is recognized in connection with a partner's legacy magnetic stripe card reader 616. In a later transaction supported by a contact-contactless transaction, a link 618 provides the data from event register 612 to a contact-contactless reader 622 and contact-contactless infrastructure 624 via the contact-contactless processor 604 and wireless connection 620. Such data can be used to accumulate “miles” or other measures that help a user earn “points” in a loyalty program, even when such was earned in a magnetic swiped transaction.

Alternative embodiments of the present invention allow the magnetic MEMS device to relay event counter or coupon information directly to other legacy magnetic stripe card readers 616. E.g., how many swipes of the card have occurred, thus giving how many power up cycles have been supported by the on-board battery. The issuing bank can then issue a new card with a fresh battery before the first card dies.

In general, embodiments of the present invention can take a number of different forms and be used for purposes other than electronic payments. These include a payment system with a contact-contactless infrastructure for processing consumer payments related to merchant transactions. A magnetic-stripe infrastructure provides for processing consumer payments related to merchant transactions. A payment card included provides for consumer purchases. A contact-contactless processor is disposed within the payment card and supporting EMV-type exchanges. A magnetic stripe is disposed on the payment card and supports legacy magnetic stripe card reader use. A magnetic MEMS device is disposed in the magnetic stripe and provides for dynamic programming of some magnetic data written to the magnetic stripe. A link between the contact-contactless processor and the magnetic MEMS device inside the payment card provides for data communication between the contact-contactless infrastructure and the magnetic-stripe infrastructure that is related to a particular user's buying behavior with the payment card.

A coupon can be communicated from the contact-contactless infrastructure through the contact-contactless processor to the magnetic MEMS device over the link for presentation to the magnetic-stripe infrastructure from the magnetic stripe to enable the redemption of a loyalty reward. A micropayment authorization may also be communicated from the contact-contactless infrastructure through the contact-contactless processor to the magnetic MEMS device over the link for presentation to the magnetic-stripe infrastructure from the magnetic stripe to enable a micropayment transaction. A transaction event count would be useful if communicated from the magnetic stripe and the magnetic MEMS device over the link for presentation to the contact-contactless infrastructure through the contact-contactless processor to enable the generation of a loyalty reward.

A second magnetic stripe can associated with a corresponding second magnetic MEMS device. A gift card surrogate could then be communicated through the contact-contactless processor to the magnetic MEMS device over the link for presentation to the magnetic-stripe infrastructure from the second magnetic stripe to enable gift card transactions.

Similarly, a prepaid card surrogate can be communicated through the contact-contactless processor to the magnetic MEMS device over the link for presentation to the magnetic-stripe infrastructure from the magnetic stripe to enable gift card transactions.

For building and physical area security applications, an access card may be communicated through the contact-contactless processor to the magnetic MEMS device over the link for presentation to the magnetic stripe infrastructure from the magnetic stripe to enable its use as a lock key. Or, a lock key is communicated from a contact-contactless interface through the contact-contactless processor to the second magnetic MEMS device over the link for interaction with the magnetic-stripe infrastructure via the second magnetic stripe to enable its use as an access card.

Broadly, a payment card has a contact-contactless processor disposed within to support EMV-type exchanges. A magnetic stripe is disposed on the payment card for supporting legacy magnetic stripe card reader use. A magnetic MEMS device is disposed in the magnetic stripe and provides for the dynamic reprogramming of some magnetic data written to the magnetic stripe. There is a unique link, between the contact-contactless processor and the magnetic MEMS device inside the payment card, which provides for data communication between a contact-contactless infrastructure and a magnetic-stripe infrastructure that is related to a particular user's buying behavior with the payment card. Data may be captured directly by the QChip or microcontroller by connecting them directly to the contactless antenna.

For example, the contact/contactless chip and interface can be used to generate a new crypto-table pointer. This would effectively scramble the table whenever a contact/contactless transaction occurs and the issuer requests it. Such field updating of the cryptography would be unique in a magnetic stripe card.

If a battery is disposed in the payment card to provide operational power for the contact-contactless processor and the magnetic MEMS device, then it would be helpful to also include a device for writing a magnetic data code to the magnetic stripe that can indicate the health of the battery to the magnetic-stripe infrastructure which would evoke a corrective action. FIGS. 1-6 show the components necessary to do this.

The payment cards can include micropayment authorizations and/or coupons communicated from the contact-contactless infrastructure through the contact-contactless processor to the magnetic MEMS device over the link for presentation to the magnetic-stripe infrastructure from the magnetic stipe to enable a small transaction, or for the redemption of a loyalty reward. A transaction event count maybe communicated in reverse from the magnetic stripe and the magnetic MEMS device over the link for presentation to the contact-contactless infrastructure through the contact-contactless processor to enable the generation of a loyalty reward. The internal link on the payment card is the critical connection between a contact-contactless processor and a MEMS magnetic device that can communicate information received from a contact-contactless payments infrastructure to be presented to a magnetic stripe payments infrastructure as specially recorded data bits written by the MEMS magnetic device in a magnetic stripe track.

In alternate embodiments, a dual use is enabled when a second magnetic stripe with a magnetic MEMS device is disposed on the payment card that is also readable by a magnetic stripe card reader. The second magnetic stripe can support magnetic data recordings for a distinct second use that would otherwise be incompatible with a primary use of the card if recorded on the first magnetic stripe.

Although particular embodiments of the present invention have been described and illustrated, such is not intended to limit the invention. Modifications and changes will no doubt become apparent to those skilled in the art, and such is intended that the invention only be limited by the scope of the appended claims.

The invention claimed is:

1. A business model for the manufacture, security, and control of payment cards used in consumer financial transactions, comprising:
circulating a population of payments cards with user identification and account access codes, wherein each use of an individual card produces a variation of its user access code according to an encryption program seeded with encryption keys or initialization vectors;
outsourcing the job of personalizing payment cards with said user identification and account access codes to a personalization company;
keeping said encryption keys and initialization vectors private from said personalization company by using said encryption program to generate tables of computed results;
sending respective ones of said tables of computed results for loading by said personalization company into new members of said population of payments cards; and
manufacturing and distributing said new members of the population of payments cards to include and operate with said tables of computed results.

2. The business model of claim 1, further comprising:
implementing machine readability of said variations of said user access codes in said population of payments cards with a magnetic MEMS device embedded in a magnetic stripe included with each payment card, wherein secure point-of-sale payments through legacy card readers are supported.

3. The business model of claim 1, further comprising:
implementing user readability of said variations of said user access codes in said population of payments cards with a display device embedded in each payment card, wherein secure on-line payments are supported.

4. The business model of claim 1, further comprising:
defining at least four digits in an industry standard 16-digit credit/debit card personal account number (PAN) to be dynamic and to communicate to an issuing bank, in real-time during a financial transaction, selected entries in a payment card's table of computed results.

5. The business model of claim 1, further comprising:
defining card verification value (CVV/CVV2) digits associated with a credit/debit card personal account number (PAN) to be dynamic and to communicate in real-time to an issuing bank, during a financial transaction, selected entries in a payment card's table of computed results.

6. A financial transaction network with improved security, wherein the network comprises a population of payments cards with user identification and account access codes, in part produced by an outsourced personalization company, the improved security realized by including:
a dynamic part in said account access codes loaded by said personalization company into each of said payment cards;
a set of encryption keys and initialization vectors kept private from said personalization company by using an encryption program to generate tables of computed results;
a transmission of respective ones of said tables of computed results for loading by said personalization company into new members of said population of payments cards; and
means for manufacturing and distributing said new members of the population of payments cards to include and operate with said tables of computed results.

7. A secure financial transaction network, comprising:
a plurality of payment cards for circulation in the commercial market and providing for the initiation of a financial transaction with a merchant, wherein payment card includes a magnetic device readable by a legacy card reader that presents dynamic magnetic data such tha each use of an individual card produces a cryptographic series of variations of a respective user access code according to an encryption program seeded with secret encryption keys or initialization vectors; and
data processing means for a payment-card issuing bank to generate said cryptographic series of variations of respective user access codes for each and all of the plurality of payment cards, to transmit to third parties for payment card manufacturing only tables of said cryptographic series of variations of respective user access code and not said secret encryption keys or initialization vectors, and to authorize financial transaction requests from a payments processor if a user access code it receives in a transaction request is a member of said cryptographic series of variations of respective user access codes for the particular one of the plurality of payment cards;
wherein, legacy magnetic card readers at merchant locations are supported, and each transaction with a particular payment card requires a unique personal account number (PAN) that will not enable subsequent fraud.

8. The secure financial transaction network of claim 7, further comprising:
visual display means included in individual ones of the plurality of payment cards that present each said unique PAN on a user display in parallel with the presentation of dynamic magnetic data so a card user can complete an on-line transaction if no legacy magnetic card reader can be involved.

9. A method of making secure payment cards for financial transactions over networks, comprising:
building payment card blanks by integrating plastic, circuit, battery, semiconductor chips, magnetic strips, magnetic MEMS device, and other components into a debit/credit card format conforming to ISO industry standards, all in response to an order from an issuing bank;
personalizing each payment card blank with at least a personal account number (PAN) of which a portion is variable according to an encryption processor and secret encryption key kept by said issuing bank, and only computed results are loaded in embedded crypto-tables for presentation during financial transactions by said magnetic MEMS device;
wherein a population of secure payment cards is produced and can be circulated for use in the commercial markets.

10. The method of claim 9, further comprising:
plasma treating the bonding surfaces of said plastic, circuit, battery, semiconductor chips, magnetic stripe, magnetic MEMS device, and other components just before their all being bonded together to better conform to said ISO industry standards.

11. The method of claim 9, further comprising:
outsourcing the job of personalizing to a third party and not allowing them to have said secret encryption key;
wherein compromising one payment card will not lead to a compromise of the security of any other of the payment cards in said population.

12. The method of claim 9, further comprising:
including means for overwriting valid digits written into a magnetic stripe shortly after being written, thus effectively disabling the magnetic use of the card;
wherein, such increases network security and translates to lower operating costs.

13. The method of claim 12, further comprising:
including means for detecting if low persistence data is captured and re-used, and using narrow time windows to identify a culprit.

14. The method of claim 9, further comprising:
including means for clearing said variable portion of said PAN a predetermined time after having presented a valid PAN for a transaction;
wherein, such increases network security and translates to lower operating costs.
